(19) United States
(12) Patent Application Publication
(10) Pub. No.: US 2003/0188177 A1
(43) Pub. Date: Oct. 2, 2003

(54) Imbebbing and defining legal rights within digitized inellectual properties

(76) Inventor: Clare L. Hoke JR., Upland, CA (US)

Correspondence Address: Clare L. Hoke Jr., Suite 11, 1318 N. Monte Vista Ave., Upland, CA, 91786, US

(21) Appl. No.: 10/107,675

(22) Filed: Mar. 26, 2002

(51) Int. Cl. H04L 9/00; H04L 9/32

(52) U.S. Cl. 713/193

(57) ABSTRACT

In digitized Intellectual Properties, clearly defining the conditions of commerce, transfer, and proliferation of Intellectual Properties within and without of digital domain. Making the legal requirements of commerce for digitized Intellectual Properties, machine and human understandable, and imbedding the legal requirements within specific Intellectual Properties. Further making the requirements themselves disruptive to an Intellectual Properties utility, until requirements as defined in said imbedded conditions are met, and defining the removal of said legal requirements for an Intellectual Property from said Intellectual Property as unlawful.

### BACKGROUND OF THE INVENTION

1. Field of the Invention

The Present Invention is in the field of Intellectual Property Management, specifically in Digital Resource Management, and encryption.

2. History of the Invention

As digitized information, computational abilities and the transfer of digital files has become ubiquitous within our society, the need for Intellectual Property Management has become apparent. The general acceptance of MP3 files for example, has spawned the greatest period and volume of Intellectual Property piracy in the history of the world. Many pre digital era business, and legal models are not holding up to the task of commerce in digital media. While recent legal challenges have stemmed the activities of organizations such as Napster, organizations such as Morpheus and Lime Line employ a decentralized network which allow them an argument of deniability to the legal ramifications of their software usage.

Beyond the piracy of Copy written music, all Intellectual Properties are currently vulnerable to piracy: performance art, video, scans, samples, voice transmissions, Design Patents, Utility Patents, cellular communications, encryption programs, software and information vital to national security.

Currently the world's largest corporations are attempting to establish market shares for Digital Resource Management.

The author of the Present Invention has filed several patents, currently pending, in the interest of identifying and protecting Intellectual Property within Digital Media. The present Invention would suggest a novel encryption method, shoring technological and legal remedy to Intellectual Property Piracy.

### SUMMARY OF THE INVENTION

Accordingly, several objects and advantages of the present invention include:

a) Making obvious the requirements of legal transfer, sale, and proliferation of Intellectual Properties within digital media.

b) Binding the requirements of legal transfer, sale, and proliferation of Intellectual Properties within digital media, to said Intellectual Properties by imbedding them within individual Intellectual Properties.

c) Defining the act of removing said imbedded legal requirements from an Intellectual Property as unlawful.

d) Making said imbedded legal requirements human and machine understandable as text, audio, visual and or voice information.

e) Imbedding said legal requirements cyclically through Intellectual Properties so as to disrupt the utility of an Intellectual property until said legal requirements imbedded within an Intellectual Property have been met.

### BRIEF DESCRIPTION OF DRAWINGS

FIG. 1 Part 1, represents the digitized elements necessary for successful, lawful commerce, and the requirements thereof (DRMm) for an Intellectual Property, which has been segmented and imbedded within an Intellectual Property—Part 2, in a cyclical, full band, or spectrum manner, so that upon exiting digital domain, Part 2 disturbs the utility (partially or fully) of said Intellectual Property.

FIG. 2 Part 3, represents the digitized elements necessary for successful, lawful commerce, and the requirements thereof (DRMm) for an Intellectual Property, which is of a different language than Part 1 in FIG. 1 and has been segmented and imbedded within an Intellectual Property—Part 5, in an alternately cyclical manner, as well as being imbedded in spectrum, or band specific regions so as to disturb the utility (partially or fully) of said Intellectual Property without first complying with said lawful requirements.

FIG. 3 Part 7, represents the digitized elements necessary for successful, lawful commerce, and the requirements thereof (DRMm) for an Intellectual Property, which is imbedded in a cyclical manner within a digitized Intellectual Property—Part 9, within digital domain, wherein Part 7 may employ similar, or dissimilar, or multiply dissimilar linguistically, or software linguistically commonalities with Part 9.

FIG. 4 Part 11, represents the humanly recognizable elements necessary for successful, lawful commerce, and the requirements thereof (DRMm), embed within an Intellectual Property Part 12; Part 12 being either in digital form, or having been also made humanly recognizable.

### DESCRIPTION OF THE PREFERRED EMBODIMENTS

Anyone versed in Law or Commerce is aware that certain conditions must be met for the binding transfer of physical or Intellectual Property. Within digital media, certain information must be present for lawful acts of commerce. Such vital information for digital commerce may include, but not be limited to:

A Transaction Code Identifier or designator, distinguishing the file as Intellectual or Copy written Property, and therefore unique and bound to restrictions with regard to transfer, ownership, and proliferation; URL code(s), the name of the property holder, the name of the distributor, deposit account information, Trademark Information, the name of the property (song title), the name of the Publisher, descriptive text strings, requirements for purchase or transfer of ownership (or further resources if such transfer may not be accomplished directly over the Internet), product incentive information for further consumer/distributor dissemination, e-mail addresses, further computer information such as a program (applet or Java for example), return form and route for documentation of sale, the name of the Internet Servers and Web Providers involved in the transfer of the file, phone numbers, HTML document(s), the front end of a program such as gopher, Internet domain name('s), the addresses of Web Servers, file type designations (audio), time/date code, FTP information, product update information, further artist information, artist tour dates and promotional material, pass words, a music sample, warranty and service information, disclaimers, and accommodations for consumer feedback, various requirements of individual transactions, “from” information, “to” information, customer information, all of the aforementioned potentially being referenced by, as, or to, via single or multiple URL resources.

For the sake of the seller or service provider, identifying information and conditions of sale, transfer and proliferation within digital media must be associated with a particular Intellectual Property within digital media. Information vital to commerce within digital media, including all, or part of the above described vital information will be referred to as the Digital Resource Management Mochila (DRMm), for the sake of the Present Invention. As the DRMm is essential to successful commerce, the Present Invention suggests that the DRMm associated with a particular Intellectual Property be embedded, cyclically within said Intellectual Property. Said cyclic embedding meaning inserting the DRMm in part, in a segmented manner, or as a whole, through the associated digitized Intellectual Property.

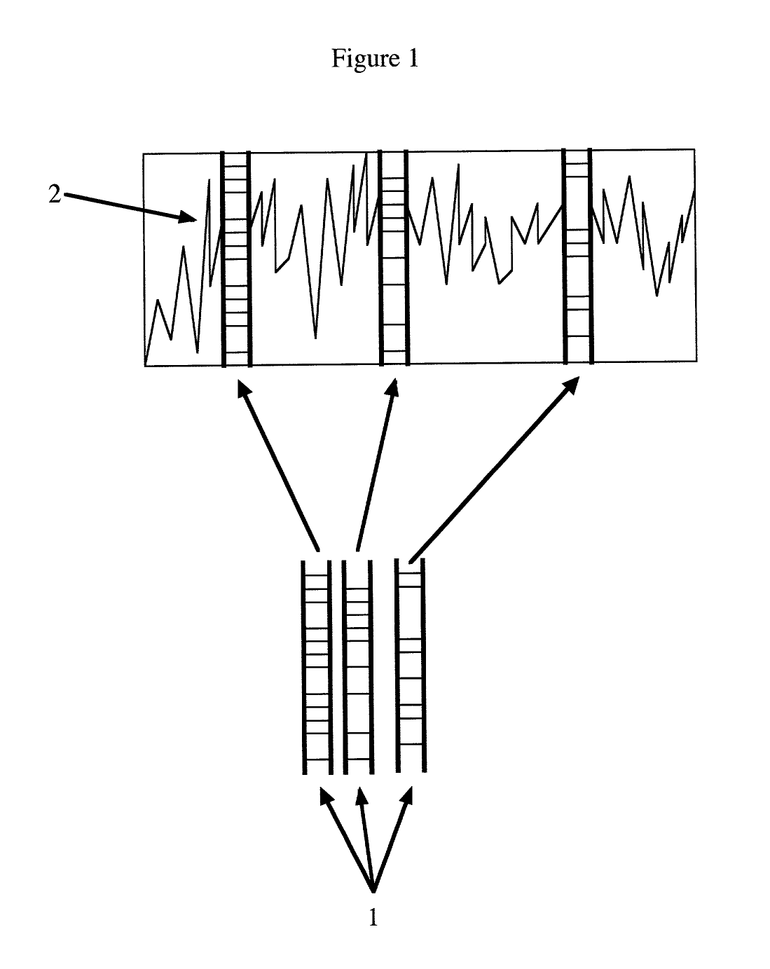

In the Preferred Embodiment of the Present Invention, the DRMm shall be of a language to be in direct conflict with the Intellectual Properties intended use. For example, in a music sound file the DRMm may introduce periodic non musical elements to the sound file, so that if played, regardless of other safeguards, or encryption, non programatic elements will disturb the enjoyment of said sound file. Prior art examples of encryption within digital media have included imbedding techniques which place information within the digital Intellectual Property file so as not to disturb the performance of the Intellectual Property, but to be recognized by machine only. FIG. 1 shows the DRMm for a particular Intellectual Property 1, being inserted full band within said Intellectual Property 2, so as to disturb the utility of the Intellectual Property, upon exiting digital domain, until the conditions delineated within 1, are met.

Further, it is herein suggested that in the Preferred Embodiment of the Present Invention, the key used to decipher the Intellectual Property upon successful purchase and transfer, shall consist of, or contain, the associated DRMm, or a modified version of the DRMm, indicative of successful commerce . . . DRMm1. Key DRMm1, shall contain the embedded information DRMm, (or a map thereof) including the particular cycle rate of DRMm within the associated Intellectual Property, so that the DRMm language may be removed from the Intellectual Property during playback, for the consumer.

To successfully engage in commerce, the customer will be exposed to the requirements of transfer, purchase, and or proliferation for a particular Intellectual Property. The requirements may be derived from DRMm, DRMm1 or from a further file associated with the intellectual Property to be purchased, DRMm2, which will not contain all of the information associated with DRMm1. In less secure environments DRMm2 may be extracted from DRMm1, using a program such as Java, and employing further encryption, before fully gaining access to DRMm1. DRMm2 may also be gained from service providers, or Intellectual Property distributors as well.

In this manner, the DRMm never leaves the Intellectual Property, except when exported from digital domain to the consumers senses.

It should be apparent to those versed in digital information management, that the methods for employing DRMm1 as a key or token to decrypt DRMm are many. The software enabling DRMm1 to successfully strip DRMm from a given Intellectual Property upon playback may reside on DRMm1, DRMm, be downloadable from distributors of Intellectual Properties, be of third party configuration, or ideally be so prevalent as to reside on most platforms upon manufacture. DRMm1 may be also be supplied on smart cards, or attached to physical objects for the sake of non internet capable appliances as well. One benefit of the Present Invention is the ease of updating the legal rights and requirements of commerce delineated on DRMm1. If a consumer has an old copy of a particular Intellectual Property imbedded with a DRMm, and desires to send the Intellectual Property to a friend, DRMm1 may be updated to delineate the current restrictions of the Intellectual Property, before the second consumer may purchase the key, DRMm1, and access the Intellectual Property.

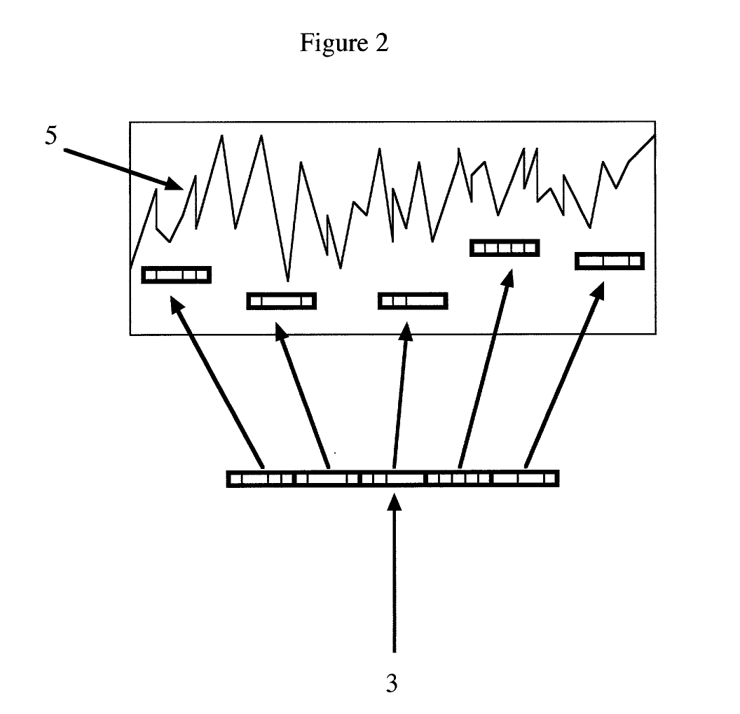

DRMm may be allocated to a particular bandwidth of the Intellectual Properties Digital information, or may be made to modulate in band frequency, and or cycle rate for additional security purposes. FIG. 2 shows DRMm 3, imbedded cyclically in spectrum, or band specific regions so as to disturb the utility (partially or fully) of said Intellectual Property without first complying with said lawful requirements.

The conditions of legal transfer as specified in DRMm and or DRMm1 may include vast variations and business models. DRMm1 may be employed with further technologies to effect scenarios where an Intellectual Property may be sampled, played, or utilized, singularly, a conditional number of times or indefinitely while being in compliance with terms specified within DRMm, DRMm1, or DRMm2.

Further, the Preferred embodiment of the Present Invention is capable of extending capabilities and business models by embracing increasingly complex software capabilities. The owner of a particular Intellectual Property may determine for example the need to allow the consumer of their Intellectual Property to make multiple copies, or a fixed number of copies of their Intellectual Property for use on multiple consumer appliances. In this instance software supporting and safeguarding such activity may be included in their DRMm, DRMm1, or may be merely associated as a separate file, or extension, or third party software charged with enforcing compliance, without leaving the scope of the Present Invention.

In the Preferred Embodiment of the Present Invention, DRMm is in effect the terms and conditions of legal sale, transfer, and proliferation within digital media. Attempting to remove the DRMm from a particular Intellectual Property shows a clear disregard for the requirements of lawful commerce, therefore constituting a knowing and willful act of piracy. Herein a consumer, or providers of software who shall attempt to strip an Intellectual Property from its DRMm, or shareware providers who associate a key (DRMm1) with an Intellectual Property without meeting the legal requirements thereof, may be regarded as willing violators of law, as delineated within digital media.

In the Preferred Embodiment of the Present Invention, DRMm shall be made to disturb the usefulness of the Intellectual Property that it is imbedded within, or associated with. Said disturbance being humanly understandable as text, voice, audio or visual information stating that the act of removing said imbedded legal requirements (DRMm) without first complying with said imbedded legal requirements shall be a willful violation of law.

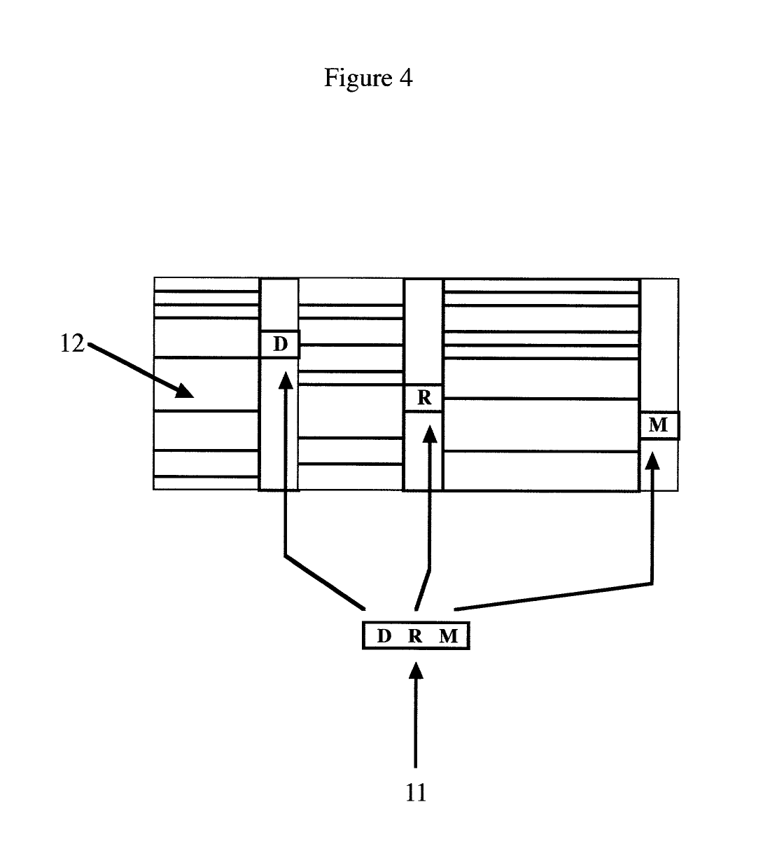

FIG. 4, shows part 11 (DRMm), embed within Intellectual Property 12 being made humanly recognizable. Making the DRMm itself readable to the consumer shall further serve to elucidate the DRMm as a legal and binding document.

The preferred languages for DRMm may be determined by convention within the market place. Proprietary languages for encoding DRMm may provide increased security for Intellectual Properties within Digital Media's, and may be preferred for reasons of corporate, private, public, or national security.

In the preferred Embodiment of the Present Invention, the DRMm may consist of multi platform languages, however the Present Invention shall not be bound to a particular computer language, software, or platform. Further the Preferred Embodiment of the Present Invention shall be utilized independent of, in addition to, or in conjunction with further encryption methods as are, or shall become available within digital media. Further DRMm1 may be encoded in association with, or independent of DRMm, or be encrypted independently, or in association with DRMm. The preferred embodiment of the Present Invention may be used in consort with further security methods and languages within the scope of the Present Invention.

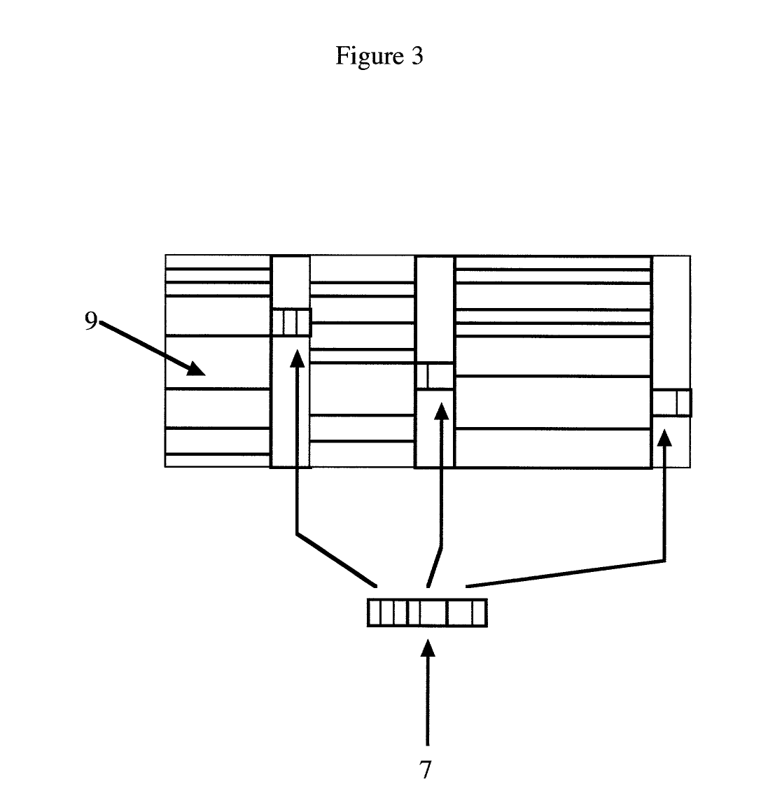

FIG. 3, shows DRMm 7 imbedded in a cyclical manner within digitized Intellectual Property 9, within digital domain, wherein Part 7 may employ similar, or dissimilar, or multiply dissimilar linguistically, or software linguistically commonalities with Part 9.

A further analysis of prevalent digital business models reveals the “platform” as an ingrained, institutionalized, and guarded aspect of software serviceability. Beyond “language” and beyond “software” extensive protective energies have been consumed in the stabilization of proprietary, and even open code platforms. Examples of platforms include Linux, Microsoft, Mac and PC. As a novel method of encryption, consistent with the Preferred Embodiment of the Present Invention, it is herein delineated that present references and or delineation's of “language” and or “software” me be alternately replaced with “platform” in consistence with the preferred embodiment of the Present Invention for the sake of encryption purposes.

In the Preferred Embodiment of the Present Invention, “platforms” may be utilized as an additional security measure. An Intellectual Property may be supplied bundled with multiple platform formats, including multiple platform DRMm information. In this manner an Intellectual Property readable upon the PC platform may be imbedded with a DRMm readable on the Mac or multiple platforms. Utilizing software queries, a potential customers platform may be determined and in this instance the above configuration would be presented” to a potential customer, who is employing a Mac platform, as the Intellectual Property is in platform conflict. Upon compliance with all legal requirements the customer could then be given access to the same Intellectual Property, which is then Mac compatible, though the DRMm imbedded in this version may be multi platform or PC compatible.

What I claim is:

1. In a Digitized Intellectual Property
Lawful digital information consisting of the digitized requirements for the lawful sale, transfer, duplication, and proliferation of an Intellectual Property, said lawful digital information being inserted in, and or throughout, said digitized Intellectual Property in a cyclical manner, either in entirety or in a segmented manner.

2. A Digitized Intellectual Property in accordance with claim 1:
and further associated with a key consisting largely, or in part of said Lawful digital information comprised of the digitized requirements for the lawful sale, transfer, duplication, and proliferation said Intellectual Property, wherein upon successfully meeting the terms contained within said lawful digital information, said key may be transferred to the individual, group, company, association or government in compliance with said lawful digital information for the purpose of employing said key to digitally remove said lawful digital information having been inserted in, and or throughout, said digitized Intellectual Property in a cyclical manner, either in entirety or in a segmented manner, during the export from digital domains, to the senses of the individual, group, company, association or government in compliance with said lawful digital information.

3. A Digitized Intellectual Property in accordance with claim 2 wherein:
said Intellectual Property is bundled within a secure container, works in consort with further methods of encryption and or security measures, is wrapped, or is imbedded with further security devices associated with digital resource management.

4. A digitized Intellectual Property in accordance with claim 3 wherein
said lawful digital information consists either jointly or several of:
a Transaction Code Identifier or designator, distinguishing the file as Intellectual or Copy written Property, and therefore unique and bound to restrictions with regard to transfer, ownership, and proliferation; URL code(s), the name of the property holder, the name of the distributor, deposit account information, Trademark Information, the name of the property (song title), the name of the Publisher, descriptive text strings, requirements for purchase or transfer of ownership (or further resources if such transfer may not be accomplished directly over the Internet), product incentive information for further consumer/distributor dissemination, e-mail addresses, further computer information such as a program (applet or Java for example), return form and route for documentation of sale, the name of the Internet Servers and Web Providers involved in the transfer of the file, phone numbers, HTML document(s), the front end of a program such as gopher, Internet domain name('s), the addresses of Web Servers, file type designations (audio), time/date code, FTP information, product update information, further artist information, artist tour dates and promotional material, pass words, a music sample, warranty and service information, disclaimers, and accommodations for consumer feedback, various requirements of individual transactions, “from” information, “to” information, customer information, all of the aforementioned potentially being referenced by, as, or to, via single or multiple URL resources.

5. A method of encryption wherein:
The digitized information consisting of the legal requirements for the successful sale, transfer and or, proliferation of a digitized Intellectual Property within digital media, be inserted in a cyclical manner, either in entirety or in a segmented manner within said digitized Intellectual Property, said legal requirements potentially containing but not being limited to:
a Transaction Code Identifier or designator, distinguishing the file as Intellectual or Copy written Property, and therefore unique and bound to restrictions with regard to transfer, ownership, and proliferation; URL code(s), the name of the property holder, the name of the distributor, deposit account information, Trademark Information, the name of the property (song title), the name of the Publisher, descriptive text strings, requirements for purchase or transfer of ownership (or further resources if such transfer may not be accomplished directly over the Internet), product incentive information for further consumer/distributor dissemination, e-mail addresses, further computer information such as a program (applet or Java for example), return form and route for documentation of sale, the name of the Internet Servers and Web Providers involved in the transfer of the file, phone numbers, HTML document(s), the front end of a program such as gopher, Internet domain name('s), the addresses of Web Servers, file type designations (audio), time/date code, FTP information, product update information, further artist information, artist tour dates and promotional material, pass words, a music sample, warranty and service information, disclaimers, and accommodations for consumer feedback, various requirements of individual transactions, “from” information, “to” information, customer information, all of the aforementioned potentially being referenced by, as, or to, via single or multiple URL resources.
said cyclical manner being modulatable for frequency, and or band with spectrum allocation, and
said digitized information consisting of the legal requirements for the successful sale, transfer and or, proliferation of a digitized Intellectual Property within digital media further being utilized either part or whole as a key to be transferred to those in compliance with said legal requirements, said key then being employed to digitally remove said digitized information inserted in said Intellectual Property during the export of said Intellectual Property from the digital domain.

6. A method of encryption in accordance with claim 5 wherein:
said Intellectual Property is bundled within a secure container, works in consort with further methods of encryption and or security measures, is wrapped, or is imbedded with further security devices associated with digital resource management.

7. A method of encryption wherein:
the legal requirements for the successful sale, transfer and or, proliferation of a digitized Intellectual Property within digital media are imbedded in said Intellectual Property in such a manner as to disturb the usefulness (partially or fully) of said Intellectual Property as a digital resource, and further making the act of removing said imbedded legal requirements without first complying with said imbedded legal requirements paramount to defacto willful violation of law.

8. A method of encryption in accordance with claim 7, wherein:
individuals, networks of individuals, organizations, or corporations, providing software to make said Intellectual Property useful as a digital resource prior to complying with said imbedded legal requirements shall be in violation of law within digital media.

9. A method of encryption in accordance with claim 8, wherein:
individuals, networks of individuals, organizations, corporations, service providers, internet providers, webmasters, or servers, trafficking or sharing methods of serving said Intellectual Property as a useful digital resource, or propagating said Intellectual Property, in violation of said legal requirements, shall be in violation of law within digital media.

10. A method of digital resource management in accordance with claim 9, wherein:
said Intellectual Property is bundled within a secure container, works in consort with further methods of encryption and or security measures, is wrapped, or is imbedded with further security devices associated with digital resource management.

11. A method of encryption wherein:
the legal requirements for the successful sale, transfer and or, proliferation of a digitized Intellectual Property within digital media are imbedded in said Intellectual Property in such a manner as to disturb the usefulness (partially or fully) of said Intellectual Property as a digital resource, and further making the act of removing said imbedded legal requirements without first complying with said imbedded legal requirements paramount to a willful violation of law, as defined within digital media, said legal requirements being both machine and human readable.

12. A method of encryption wherein:
the legal requirements for the successful sale, transfer and or, proliferation of a digitized Intellectual Property within digital media are imbedded in said Intellectual Property in such a manner as to disturb the usefulness (partially or fully) of said Intellectual Property as a digital resource, said disturbance being humanly understandable as text, voice, audio or visual information stating that the act of removing said imbedded legal requirements without first complying with said imbedded legal requirements is paramount to a willful violation of law.

13. A method of encryption in accordance with claim 12 wherein: the legal requirements for the successful sale, transfer and or, proliferation of a digitized Intellectual Property within digital media are imbedded in said Intellectual Property in a cyclical manner, either in entirety or in a segmented manner, in such a manner as to disturb the usefulness (partially or fully) of said Intellectual Property as a digital resource, said disturbance being humanly understandable as text, voice, audio or visual information stating that the act of removing said imbedded legal requirements without first complying with said imbedded legal requirements is paramount to defacto willful violation of law, said method of encryption being capable of being bundled within a secure container, working in consort with further methods of encryption and or security measures, being wrapped, or imbedded with further security devices as associated with digital resource management.

14. A method of encryption in accordance with claim 13 wherein:
said disturbance is humanly and machine understandable, upon multiple digital platforms, and in multiple human and machine languages.

15. A method of encryption in accordance with claim 14 wherein:
single, and or polylingustic software languages are employed to disrupt the utilization of an Intellectual Property, until the legal requirements of said Intellectual Property are met; said legal requirements being imbedded within said Intellectual Property, by said single and or poly linguistic software languages, and further being extracted by key, cypher, token, or program, from said Intellectual Property upon compliance of said imbedded legal requirements.

16. A method of encryption wherein:
single, and or poly linguistic software languages are employed to disrupt the utilization of an Intellectual Property, until the legal requirements of said Intellectual Property are met; said legal requirements being imbedded within said Intellectual Property, by said single and or poly linguistic software languages, and further being extracted by key, cypher, token, or program, from said Intellectual Property upon compliance of said imbedded legal requirements.

17. In a digitized Intellectual Property:
the employment of multiple computer software “platforms” for the purpose of disrupting the utility of said Intellectual Property until the legal requirements of sale, transfer and or proliferation are met.
